(19) United States
(12) Patent Application Publication
(10) Pub. No.: US 2005/0072761 A1
(43) Pub. Date: Apr. 7, 2005

(54) Gas metal arc welding of uncoated steels and shielding gas therefor

(76) Inventors: Earl D. Colvin, Nuevo, CA (US); Jeff D. Leonard, Murray, UT (US); Jeffrey D. Mitchelson, Fullerton, CA (US)

Correspondence Address: PRAXAIR, INC.;LAW DEPARTMENT - M1 557, 39 OLD RIDGEBURY ROAD, DANBURY, CT, 06810-5113, US

(21) Appl. No.: 10/920,332

(22) Filed: Aug. 18, 2004

Related U.S. Application Data
(60) Provisional application No. 60/495,925, filed on Aug. 18, 2003.

(51) Int. Cl. B23K 9/173

(52) U.S. Cl. 219/74; 219/137 R

(57) ABSTRACT

This invention relates to a method for gas metal arc welding of uncoated steels, and a shielding gas therefor, in which the method comprises: (a) forming an arc between a consumable wire electrode and an uncoated steel workpiece; (b) maintaining a substantially constant arc voltage between said consumable wire electrode and the uncoated steel workpiece; (c) feeding the consumable wire electrode through a welding torch contact tube into said arc; (d) transferring metal from the consumable wire electrode to the uncoated steel workpiece; and (e) shielding the arc with a gas mixture consisting essentially of: (i) from 5 to 9 volume percent carbon dioxide; (ii) from 8 to 12 volume percent helium; and (iii) the balance argon.

### FIELD OF THE INVENTION

This invention relates to gas metal arc welding and more particularly, to an improved process for gas metal arc welding which can significantly improve weld quality and appearance as well as provide higher productivity for welding uncoated steels, e.g., carbon steel and stainless steel.

### BACKGROUND OF THE INVENTION

Gas metal arc welding, commonly referred to as “GMAW” or “MIG” welding, is an electric arc welding process in which the arc is shielded from the ambient atmosphere by a gas or a mixture of gases. Metal is transferred to a workpiece through the arc from a consumable wire electrode. The consumable wire electrode is continuously fed into the arc at a preselected speed corresponding to a given deposition rate for a given wire size.

The optimum type of metal transfer employed with the gas metal arc process is a spray arc where fine metal droplets are transferred in a very controlled manner across the arc gap. Very little spatter is produced using this welding technique. The type of metal transfer can be obtained only with a certain combination of shielding gases and welding parameters and thus is generally produced only within a fairly narrow range of conditions.

Typically gas metal arc welding shielding gases have comprised solely carbon dioxide or have comprised mixtures of argon, carbon dioxide oxygen or helium. Each known shielding gas has a specific known range within which the process with that gas will perform acceptably well. Helium, if employed in the gas mixture, is present in a concentration generally exceeding 20 percent and is used to impart special characteristics to the weld but only when its high cost can be justified.

Typical problems experienced when arc welding uncoated steels include overweld, poor bead appearance, spatter and porosity. These can result in lower welder duty cycle and increased weld cost associated with post weld repairs and clean up. In many applications, poor weld bead appearance, poor weld quality and the subsequent reduced productivity are significant problems for the fabricator. Existing shielding gas/wire combinations for gas metal arc welding leave room for improvement.

Accordingly, it is an object of this invention to provide an improved gas metal arc welding method which can effectively reduce weld spatter, increase bead wetting and minimize porosity when joining uncoated steels. This overall improvement in weld quality will lead to higher productivity and reduced welding costs for the user.

It is another object of this invention to provide an improved gas metal arc welding method which can employ a shielding gas which does not require the presence of a large concentration of helium and yet achieves a comparable improvement in desired weld characteristics.

### SUMMARY OF THE INVENTION

This invention relates in part to a method for gas metal arc welding with a consumable wire electrode comprising:

(a) forming an arc between said consumable wire electrode and a uncoated steel workpiece;

(b) maintaining a substantially constant arc voltage between said consumable wire electrode and the uncoated steel workpiece;

(c) feeding the consumable wire electrode through a welding torch contact tube into said arc;

(d) transferring metal from the consumable wire electrode to the uncoated steel workpiece; and

(e) shielding the arc with a gas mixture consisting essentially of:
(i) from 5 to 9 volume percent carbon dioxide;
(ii) from 8 to 12 volume percent helium; and
(iii) the balance argon.

This invention also relates in part to a shielding gas mixture for use with gas metal arc welding of uncoated steels consisting essentially of:
(i) from 5 to 9 volume percent carbon dioxide;
(ii) from 8 to 12 volume percent helium; and
(iii) the balance argon.

As used herein, the term “uncoated steel” means carbon steel and stainless steel. Carbon steel means an alloy of iron and carbon wherein the carbon concentration generally does not exceed 0.5 percent, wherein manganese may be present in a concentration generally not exceeding 1.65 percent, wherein copper and silicon may be present in concentrations not exceeding 0.6 percent, and other alloy elements are generally not present except in residual amounts. Stainless steel means a steel from a group of highly alloyed materials, primarily alloys of iron and chromium where the chromium content may be in the range of from 10 to 30 percent. Other alloying elements such as nickel within the range of from 1 to 22 percent and manganese within the range of from 0.5 to 10 percent may also be included.

### BRIEF DESCRIPTION OF THE DRAWING

FIG. 1 is a schematic diagram of an illustrative system useful for carrying out the method of this invention.

### DETAILED DESCRIPTION OF THE INVENTION

As indicated above, this invention relates in part to method for gas metal arc welding with a consumable wire electrode comprising:

(a) forming an arc between said consumable wire electrode and an uncoated steel workpiece;

(b) maintaining a substantially constant arc voltage between said consumable wire electrode and the uncoated steel workpiece;

(c) feeding the consumable wire electrode through a welding torch contact tube into said arc;

(d) transferring metal from the consumable wire electrode to the uncoated steel workpiece; and

(e) shielding the arc with a gas mixture consisting essentially of:
(i) from 5 to 9 volume percent carbon dioxide;
(ii) from 8 to 12 volume percent helium; and
(iii) the balance argon.

This invention also relates in part to a shielding gas mixture for use with gas metal arc welding of uncoated steels consisting essentially of:
(i) from 5 to 9 volume percent carbon dioxide;
(ii) from 8 to 12 volume percent helium; and
(iii) the balance argon.

The shielding gas mixtures of this invention have the unique ability to modify the transition level of most ferrous gas metal arc welding applications expanding the stable operating range of 0.023 through 0.062 diameter solid wires. This allows for an increase in weld deposition rate and as a result, improved productivity and reduced welding cost. The shielding gas mixtures of this invention also have the unique capability of expanding the stable operating range of all metal cored wires as well as flux cored wires designed to operate with higher argon levels. The shielding gas mixtures allow users to maintain maximum manufacturing flexibility through the use of one gas mixture and multiple wire types without compromises normally associated with other gas mixtures available in the marketplace. The shielding gas mixtures are cost effective and easy to implement in either cylinder packaging or bulk form.

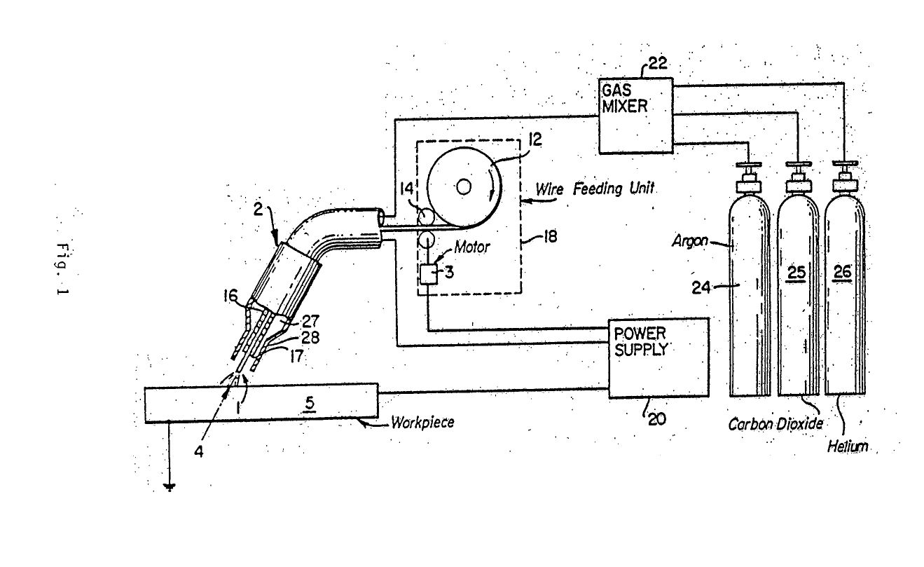

The invention can be described in further detail with reference to FIG. 1. Referring to FIG. 1, consumable wire electrode 1 is drawn from reel 12 by feed roll 14 through contact tube 16 in gas shielded arc welding torch 2. The consumable wire electrode may have a diameter within the range of from 0.023 to 0.062 inch and may be composed of any suitable metal composition appropriate for the particular welding application. The consumable wire electrode may be a solid wire, a metal-cored wire, or a flux-cored wire developed to weld on uncoated steels. Solid GMAW wires with an American Welding Society (AWS) classification of ER70S-X are preferred for use in this invention.

The method of this invention works well with 0.040 inch diameter wire and thus allows a wide range of operation spanning the 0.035/0.045 gap and allows the use of multiple wire types and one gas mixture for many applications. The method of this invention increases the useful operating range at both the high end and the low end of the stable operating range for a consumable/wire combination. This allows for the deposition of larger quantities of weld metal without causing a deterioration in weld appearance, weld quality, or weld properties.

Any suitable gas shielded torch may be used to carry out the method of this invention. The torch may be either manually operated or mechanized. In the embodiment illustrated in FIG. 1, torch 2 is a mechanized torch. Feed roll 14 is driven by drive motor 3 contained in wire feeding unit 18 which can feed wire at the speeds necessary to achieve the desired deposition rates.

Power supply 20 supplies power to both wire feeding unit 18 and torch 2. Power supply 20 is voltage controlled and of the constant potential type.

In operation, an arc 4 is established between consumable electrode 1 and workpiece 5 by energizing power supply 20 feeding the electrode into direct contact with the workpiece. The arc voltage between the electrode and the workpiece is kept substantially constant during the welding process. By “substantially constant” it is meant that the arc voltage varies not more than 5 percent from the set point during the welding process. The arc voltage setpoint is at a point where a stable arc can be achieved for whichever transfer mode is chosen. The method of this invention is particularly advantageous for use with the short circuiting transfer, spray transfer, and pulsed spray transfer modes of metal transfer. The substantially constant voltage allows for a self-regulating welding condition in that as the arc length varies during welding, the wire melt off rate also varies to keep the arc voltage substantially constant. This allows for stable welding conditions to be maintained with uniform weld penetration and bead shape. The arc voltage is generally within the range of from about 17 to 40 volts, preferably from about 22 to 32 volts, with the current varying between 150 to 275 amperes. The consumable wire electrode is fed through welding torch contact tube 16 into the arc and metal is transferred from the electrode to the workpiece. The preferred welding position is in the horizontal or flat position.

The electrode 1 is fed through the contact tube 16 into the arc 4 formed between the electrode 1 and workpiece 5. Contact tube 16 is connected through torch 2 to power supply 20 for supplying power to electrode 1. Workpiece 5 is connected to ground in common with the power supply ground.

The arc is shielded from the ambient atmosphere by a gas mixture consisting essentially of from 5 to 9 percent, preferably from 6 to 8 percent, and more preferably 6.5 to 7.5 percent carbon dioxide, from 8 to 12 percent, preferably from 9 to 11 percent, and more preferably from 9.5 to 10.5 percent helium, with the balance being argon. The percentages are in volume percent. A carbon dioxide concentration in the shielding gas lower than about 5 percent or greater than about 9 percent may have a deleterious effect on the weld quality. A helium concentration in the shielding gas lower than about 8 percent or greater than about 12 percent may have a deleterious effect on the weld quality.

In a preferred embodiment, the shielding gas composition should contain about 10 percent helium, about 7 percent carbon dioxide and the balance argon with a flow of gas to the weld zone of about 35 to 50 cubic feet per hour. When welding uncoated steels, quality is based mainly on three factors: porosity, spatter and weld bead appearance. Porosity and spatter should be as low as possible.

Referring to FIG. 1, the shielding gas mixture useful with this invention may be made up within gas mixer 22 which receives the component gases from cylinders 24, 25 and 26. For example, cylinder 24 may contain argon, cylinder 25 may contain carbon dioxide and cylinder 26 may contain helium. Any other suitable gas storage container, such as a storage tank, may also be employed in conjunction with this invention. Gas mixer 22 can be any conventional gas mixer which can be set to meter the appropriate gas from each gas source to establish the gas mixture useful in this invention. Alternatively, the gas mixture of this invention may be supplied already mixed from a single container.

The shielding gas mixture useful in this invention is then passed through conduit means 6 to torch 2 and is passed through space 27 between contact tube 16 and torch cup 28 so that it forms a shroud for shielding arc 4 from the ambient atmosphere.

The gas metal arc welding method and shielding gas mixture of this invention enables the attainment of high quality welds with excellent appearance at increased levels of productivity. This is particularly important in the welding of uncoated steels where quality and cost reduction are important factors. The preferred uncoated steels useful in this invention include carbon steel and stainless steel. The method of this invention may be used for applications on thin as well as thick materials. Useful applications include computer cabinets, industrial fans, wine racks, exercise equipment, furniture manufacturing and automotive wheels.

The gas metal arc welding method and shielding gas mixture of this invention have also enabled the attainment of high quality welds with reduced defects in the welding of uncoated steels. This invention employs a combination of shielding gas, wire type, metal transfer and process type. This combination substantially improves the quality and appearance of welds on uncoated steels. A major factor in this benefit is the shielding gas composition selected for use with the other method variables. The improvements produced include fewer defects, e.g., less spatter, reduced porosity, and overall better bead appearance. Bead crowning is reduced (less overweld). Productivity increases up to 20 percent or greater may be achieved due to the decreased amount of post-weld clean up and rework. The method of this invention works particularly well over surface contamination, e.g., rust, oil and mill scale, and reduces spatter and improves bead appearance over a wide operating range. In a preferred embodiment, the practice of the method of this invention involves gas metal arc welding with pulsed metal transfer, a solid wire, a shielding gas composition of carbon dioxide (7 percent), helium (10 percent) and argon (balance), for welding an uncoated steel base material.

Heretofore, the ability to achieve high quality welds over a range of operating conditions and deposition rates in gas metal arc welding required a shielding gas mixture containing a high concentration of helium or the presence of oxygen in conjunction with helium carbon dioxide and argon. The shielding gas mixtures of this invention enables excellent gas metal arc welding utilizing metal transfer by various methods without using either an expensive mixture containing a high concentration of helium or a complex mixture which includes oxygen.

Various modifications and variations of this invention will be obvious to a worker skilled in the art and it is to be understood that such modifications and variations are to be included within the purview of this application and the spirit and scope of the claims.

1. A method for gas metal arc welding with a consumable wire electrode comprising:
(a) forming an arc between said consumable wire electrode and an uncoated steel workpiece;
(b) maintaining a substantially constant arc voltage between said consumable wire electrode and the uncoated steel workpiece;
(c) feeding the consumable wire electrode through a welding torch contact tube into said arc;
(d) transferring metal from the consumable wire electrode to the uncoated steel workpiece; and
(e) shielding the arc with a gas mixture consisting essentially of:
(i) from 5 to 9 volume percent carbon dioxide;
(ii) from 8 to 12 volume percent helium; and
(iii) the balance argon.

2. The method of claim 1 wherein the carbon dioxide concentration is within the range of from about 6 to 8 volume percent.

3. The method of claim 1 wherein the carbon dioxide concentration is within the range of from about 6.5 to 7.5 volume percent.

4. The method of claim 1 wherein the helium concentration is within the range of from about 9 to 11 volume percent.

5. The method of claim 1 wherein the helium concentration is within the range of from about 9.5 to 10.5 volume percent.

6. The method of claim 1 wherein the electrode has a diameter within the range of from about 0.023 to 0.062 inch.

7. The method of claim 1 wherein the arc voltage is within the range of from about 22 to 32 volts.

8. The method of claim 1 wherein the consumable wire electrode is a solid wire, a metal-cored wire or a flux-cored wire.

9. The method of claim 1 wherein the uncoated steel comprises carbon steel.

10. The method of claim 1 which employs a short circuiting transfer, spray transfer or pulsed spray transfer mode of metal transfer.

11. The method of claim 1 wherein the carbon dioxide concentration is within the range of from about 6.5 to 7.5 volume percent, the helium concentration is within the range of from about 9.5 to 10.5 volume percent, the consumable wire electrode is a solid wire, and which method employs a pulsed spray transfer mode of metal transfer.

12. A shielding gas mixture for use with gas metal arc welding of uncoated steels consisting essentially of:
(a) from 5 to 9 volume percent carbon dioxide;
(b) from 8 to 12 volume percent helium; and
(c) the balance argon.

13. The shielding gas mixture of claim 12 wherein the carbon dioxide concentration is within the range of from about 6 to 8 volume percent.

14. The shielding gas mixture of claim 12 wherein the carbon dioxide concentration is within the range of from about 6.5 to 7.5 volume percent.

15. The method of claim 12 wherein the helium concentration is within the range of from about 9 to 11 volume percent.

16. The method of claim 12 wherein the helium concentration is within the range of from about 9.5 to 10.5 volume percent.
